(19) United States
(12) Patent Application Publication
(10) Pub. No.: US 2013/0014961 A1
(43) Pub. Date: Jan. 17, 2013

(54) MODULAR AUTOMATIC SPRAY NOZZLE

(71) Applicant: Carsten Palle, Svendborg (DK)

(72) Inventor: Carsten Palle, Svendborg (DK)

(73) Assignee: VID Fire-Kill ApS, Svendborg (DK)

(21) Appl. No.: 13/582,147

(22) PCT Filed: Mar. 4, 2011
(86) PCT No.: PCT/DK11/50068

§ 371 Date: Sep. 14, 2012

(30) Foreign Application Priority Data
Mar. 4, 2010 (DK) PA 2010 70086

(51) Int. Cl. A62C 37/11

(52) U.S. Cl. 169/37

(57) ABSTRACT

An automatic spray nozzle arrangement, which comprises a nozzle casing having a cavity, with inlet and outlet openings, in which a nozzle arrangement is kept inside by means of a plate, which is characterized by the plate being located in the outlet opening of the nozzle casing by help of an automatic thermal release element, which demolishes from heat exposure, and where the release element via one or two brackets, which are fixated in one or two points attached to casing fixate, fixate the plate in the nozzle casing.

The present invention concerns a spray nozzle design to be applied in automatic sprinklers and water mist sprayer and multiple jet control valves for active fire protection with liquid extinguishing agents.

It is known technology on automatic sprinkler heads and automatic water mist sprayers and multiple jet control valves to have inlet ports, which are sealed with a plug which are fixated to seal the inlet ports by means of a vertical positioned thermal release element in the shape of a liquid filled glass container or solder link, which at the one end rest on a yoke, and at the other end apply a force on the seal plug to keep the inlet sealed. A problem with this design is that the product must be installed with the full length of the release element below ceiling or outside walls in order to exposed the whole thermal element to hot gasses from a fire, to achieve good fire responses on the equipment. This makes the installed equipment woundable to physical damages and architectural visible in the fire protected spaces.

The above problems have been tried solved in a known sprinkler design where the sprinkler head is located concealed in a cup, which are installed concealed in ceilings with its opening in a downward position, and where the cup opening is hidden with a cover plate, which are soldered on the cup opening flange with solder having low melting temperatures, and which detaches at low temperatures to expose the heat sensitive release element of the sprinkler head to the heat of fire.

A disadvantage with the above design is that the sprinkler becomes a technical complex design, and that the sprinkler design delay the response time of sprinkler heads, with the cover plate release time, and the time here after to heat the concealed sprinkler head in the cup from heat of fire.

The above problems has been tried solved with openings in the cup bottom, and a slot opening between the cover plate and the cup opening flange to allow the thermics from fire creating a hot air flow heating the sprinkler head and it's thermal release element.

A disadvantage with the above method is insulation materials and other impurities above the ceiling risks to close the openings causing delayed response times, and in worse case causing the concealed sprinkler head not operating in case of fire.

It is known that the above problems have been tried solved in sprinkler heads and multiple jet control valve designs, where the inlet port are sealed with a plug, which are kept in its position from a body applying a force to the sealing, and where the body at it's end opposite the sealing is supported from one or two support brackets resting on both the end of the body and on the sprinkler or valve casing, and where a thermal release element applies a force to the support brackets, which fixates the support brackets to the sprinkler or valve housing allows the support brackets to rest on the casing to supply a force to the body, to keep the plug sealing the sprinkler or valve inlet port.

A disadvantage with the known method described above is that the fragile heat sensitive release element is located in a free location outside the sprinkler head or multiple jet control casing, making the sprinkler or valve very fragile to physical impacts, abuses and vandalism.

The above problems is known to have tried being solved by fitting a protection cover below the heat sensitive release element. This cover is fitted after the installation of the sprinkler in the ceiling. The cover is fitted with brackets holding on to the sprinkler rosette. The cover is fitted after the sprinkler with rosette has been installed in the ceiling, and the cover has a lose fit, allowing the cover to be knocked off from the force of water in the sprinkler inlet when the sprinkler releases from heat of fire, to freely distribute extinguishing agents to place on fire.

A disadvantage with the above described known design is that the protection cover first may be fitted after the sprinkler has been installed, which means that the fragile support arrangement and the fragile heat release element below the sprinkler head risks to be exposed to physical abuse during transportation and handling and installation in ceiling. Another disadvantage with the above design is that the cover needs to have a lose fit to fall off when the sprinkler activates. Which cause high risks of covers falling off when exposed to vibrations.

Another disadvantage of the known designs of sprinklers and automatic water mist nozzles with or without covers is that the sprinklers and water mist nozzles contain moving parts, and especially water mist nozzles often includes relatively small orifices. The sprinklers and water mist nozzles are often installed in corrosive environments where the sensitive elements are exposed to corrosive atmospheres like salts etc. Corrosion does hereby represent risks of malfunctioning from corroding, internal parts and moving parts corroding together loose of strengths of internal parts and corrosion blocking small orifices etc.

The above corrosion problem is solved by corrosion resistant plating internal parts, and making internal parts in noble materials. The above methods applies extra manufacturing costs to products, and makes it more difficult to recycle products after end use.

The purpose of the new invention is to apply a more practical solution to the above listed problems and disadvantages for automatic sprinkler and water mist sprayer heads.

The invention concerns an automatic nozzle arrangement consisting of a hollow body with an inlet and an outlet opening, which are characteristic in including an arrangement where the outlet opening has a cone shaped outlet with minimum two appendixes symmetrical located 180° from each other on the periphery of the opening, and where a plate or body are positioned to close the outlet opening, and where the plate are fixated between a recess in the outlet cavity and two fixture brackets, which each rest in a grove in the appendix material on the outlet periphery, and where one or both fixture brackets have a load screw, and where a thermal release element is located with its two ends fixated in the space between the fixture bracket, and where the distance between the two fixture brackets are fixated to the distance between the ends of the thermal release element plus the free length of the load screw located between the two fixture brackets.

The invention activates when the heat of a fire or heat of electric resistance element breaks down the thermal release element. When the thermal release element disintegrates the force, which holds the fixture brackets in place disappear. The force of the extinguishing agent pressure or air pressure, acting on the inlet port of the apparatus, does hereafter become larger than the force keeping the spherical plate in its position at the housing cavity opening, and the spherical plate is hereafter released. This allows the hydraulic extinguishing agent pressure, or an air pressure, acting on the inlet port of the apparatus to move the nozzle body in the housing cavity, until it is stopped from falling out when a convex cone surface on the nozzle body surface forms a seal with a concave cone surface at the housing cavity outlet. The seal of the inlet port is hereby broken and extinguishing agent flows freely from the pipe through the inlet port of the housing, through the housing cavity, through the hollow nozzle body, from where extinguishing agent is distributed to the place on fire.

A variant of the invention is characteristic in that the spherical plate close the nozzle house cavity outlet, and the hollow nozzle body inside the nozzle housing cavity at its one end rest on the spherical plate and at its other end holds a seal sealing the inlet port to the nozzle house cavity.

A variant of the above variant of the invention is characteristic in that the nozzle house consists of two or more bodies which are assembled together, and where the one of these bodies is a release body, which are fitted to form the end of the nozzle body opposite the nozzle body end with the inlet port, and where the release body contains the spherical plate, the brackets holding the spherical plate and the thermal release element holding the brackets in place which hold the spherical plate in place. The above variant of the invention allows nozzles and multiple jet control valves to be modular build with the use of preassembled and pretested release bodies to be assembled to the nozzles or multiple jet control bodies.

Another variant of the invention is characterized by that the spherical plate forms a leak proof seal at the nozzle house cavity outlet. The above variant performs with that the spherical plate eventual with a sealing like an o-ring or a gasket between the spherical plate and a recess etc. seals the outlet of the nozzle house cavity, and keeps a hollow nozzle body inside the nozzle house cavity together with the liquid extinguishing agent until the thermal release element is released from heat of fire, and the nozzle body inside the nozzle house cavity are pushed out of the nozzle house cavity to distribute extinguishing agent to place on fire.

A third variant of the invention is characterized by spherical plate having a cylindrical surface, which seals with a seal against a cylindrical surface in the outlet of the nozzle house cavity, and which at its end surface rest on the brackets being fixated with a thermal release element. The above variant reduces the force on the holding brackets holding the spherical plate, and being hold in place by a thermal release element. The invention variant does also allow the spherical plate to be fitted after that the brackets and the thermal release element has been fitted.

A fourth variant of the invention is characterized by that the spherical plate body support a nozzle body in the nozzle house cavity which fixate a sealing device, which seals the inlet port to the nozzle house cavity. The above variant performs by sealing both inlet and outlet of the housing cavity, which keeps the hollow nozzle body inside the housing cavity, and which prevent extinguishing agent from flowing into the house cavity, and debris and impurities in the surrounding atmosphere from coming in contact with the nozzle body inside the housing cavity. The variant does also perform as a double seal against extinguishing agent leaking from the nozzle housing.

A fifth variant of the invention is characterized by that the spherical plate on its surface pointing away from the housing cavity has one or multiple enlargements of which the one is positioned in the extension of the thermal release element and has a cavity in the extended symmetry line of the thermal release element, and where a pin or a spherical ball is located. The variant works with that the thermal release element applies a force on the pin or spherical ball, which locks the spherical plate in its position at the end of the nozzle housing cavity for as long as the thermal release element is intact.

A sixth variant of the invention is characterised in that the spherical plate has one or multiple fins on the side pointing against the heat sensitive release element, and where one or multiple of the fins are not parallel with the centreline of the thermal release element. The variant works with that the fins guides the flow of hot air from a fire around the thermal release element, which will result in faster response times to a fire close to the invention.

A seventh variant of the invention is characterized by that the extension body between the thermal release element and its support point, are in the shape of being spring element, which supplies a force which keeps the spherical plate fixed in the outlet of the nozzle cavity.

An eighth variant of the invention is characterized by having a cover plate formed with brackets which are attached to the spherical plate in such .a way that the heat sensitive release element is positioned between the two parallel plates. In this variant of the invention, the thermal release element is located in a protected location behind a cover plate. Furthermore the cover plate provides an architectural finish to the nozzle arrangement when the nozzle is installed recessed in ceilings. In a fire situation the heat of fire flows through the slot between the spherical plate and the cover plate to heat the thermal release element to activation. When heat of fire releases the thermal release element, the force locking the brackets holding the spherical plate in its position at the housing cavity outlet, disappears and the force of the agent pressure in the pipe work forces the nozzle body out of the housing cavity, pushing thee spherical plate with the cover plate away from the nozzle housing allowing the nozzle body to come out of the nozzle housing cavity to distribute extinguishing agent on place on fire.

A variant of the invention which is designed for pendent and horizontal installation in pipes is characterized by its design of the nozzle body, which consists of two or multiple elements which are assembled to be a top nozzle body part and bottom nozzle body part, which are assembled together to become one nozzle body with a central longitudinal cavity with inlet openings in the nozzle bottom body part, and the nozzle top body part containing a central cavity in its longitude direction with a top end with one or multiple outlet openings. The assembled nozzle body is contained in the nozzle housing cavity, where the nozzle bottom body part forms a seal to inlet to nozzle housing cavity, and the nozzle top body part rest at the spherical plate, which are located at the outlet of the nozzle house cavity, and which are kept in place by one or two brackets which are locked on place with a force which a thermal rerelease element applies.

The above variant of the invention performs when the heat of fire releases the thermal release element, and the lock force on the brackets holding the spherical plate disappears, and the spherical plate freely falls away. The force of the agent pressure acting at the inlet port pushes the nozzle body out of the nozzle house cavity. The bottom nozzle body part travels away for the inlet to nozzle housing cavity, which makes the seal of the inlet port disappears, and the extinguishing agent is free to flow into the nozzle housing cavity, and to flow through the opening in the bottom nozzle part into the lengthy cavity in the assembled nozzle body, and out of the openings in the nozzle body top part and from here on to the place on fire.

A variant of the invention for installation in upright position are characterized by the movable nozzle body consists of two or multiple arts, which consists of a top nozzle body part and a bottom nozzle body part where the bottom nozzle part has the shape of a cup contains a central cavity and a bottom, and where the bottom contains one or multiple openings, and where the cylinder surface of the bottom nozzle body part contains one or multiple openings into the cup cavity, And where a top nozzle body part having a concave surface is located in a distance of 0.2 mm to 2 mm from the cup periphery of the bottom nozzle part. The above variant functions with that heat of a fire releases the thermal release element locking the brackets holding the spherical plate in the outlet of the nozzle housing cavity. The brackets falls off, and the spherical plate are hereafter free to fall off the nozzle house opening, and the agent pressure acting at the nozzle house inlet port are hereafter cable of pushing the nozzle body out of the now free nozzle house opening, which releases the seal of the nozzle house cavity inlet, and extinguishing agent flows freely from pipe work through the nozzle house inlet port into the nozzle house cavity, and from here through the openings in the cup bottom of the nozzle bottom body part, and into the central cavity of the nozzle body, and from here on to the concave surface on the nozzle top body, from where the extinguishing agent is distributed in down ward direction in the form of a thin liquid extinguishing agent film. Extinguishing agent also flows through the openings in the cylindrical surface of the bottom nozzle part. The jets from the openings meets the film of extinguishing agent in the atmosphere surrounding the nozzle, and the kinetic energies of agent sprays colliding transform the agent sprays from film and jets to a cloud of small water droplets where 70% to 100% of the extinguishing agent being distributed are distributed in droplets having sizes below 1 mm in diameter.

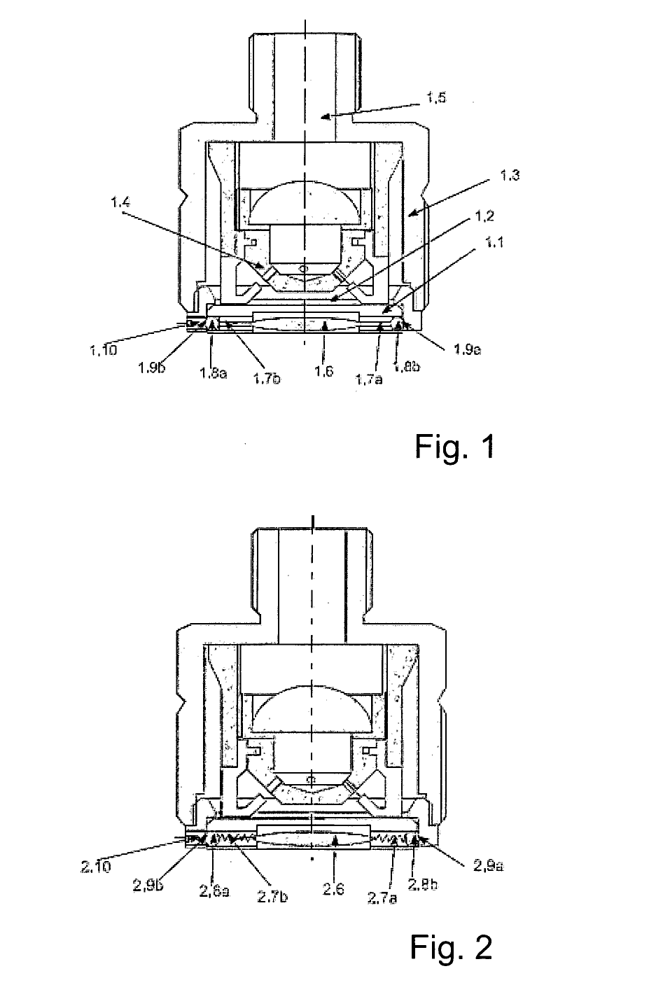

FIG. 1 shows an example on the invention, where a spherical plate body (1.1) is located to close the outlet of a cavity (1.2) in a hollow cup shaped nozzle house body (1.3) containing a nozzle body arrangement (1.4) and an inlet port (1.5), and where a thermal release element (1.6), via two bodies with shapes of pipes (1.7a & 1.7b) which is located in two guide cavities, keeps two spherical surfaces (1.8a & 1.8b) locked against two contacts surfaces (1.9a & 1.9a), where the one contact surface is located at the end of a threaded connection (1.10) connected to the hollow body.

FIG. 2 shows an example on the invention where a thermal release element (2.6) via two spring bodies (2.7a, 2.7b) in guiding cavities supplies a locking force on two locking devices keeping a spherical plate body positioned in the outlet of the nozzle housing cavity.

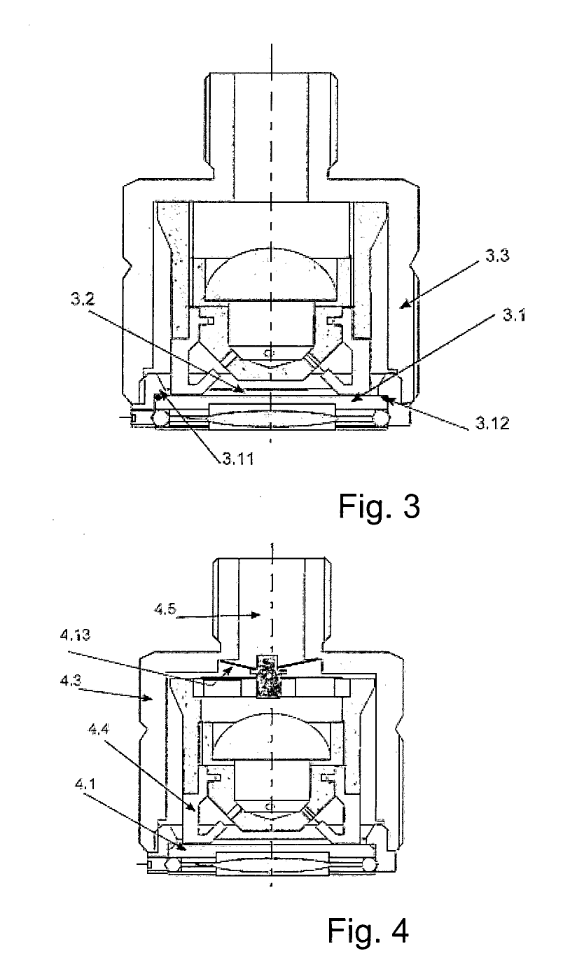

FIG. 3 shows an example on the invention where a flat plate body arrangement is located in the cavity of a cup shaped nozzle house with a nozzle body arrangement located in the nozzle house cavity having an inlet port to the nozzle house cavity with the nozzle body arrangement, and where a thermal release element via two bodies in the shape of guiding cavities with a spherical ball locks a spherical plate (3.2) in place in the outlet opening of the nozzle housing, having an convex cavity opening surface (3.11) and where the spherical plate (3.1) with a gasket or an o-ring etc. (3.12) seals the nozzle house cavity outlet (3.11) preventing extinguishing agent from leaking from the nozzle house cavity, until the thermal release element has released, to un-lock the spherical plate body.

FIG. 4 shows an example on the invention where the nozzle arrangement (4.4) rests on a spherical plate body (4.1) which are locked in place in the outlet of the nozzle house cavity, and where a sealing arrangement (4.13) is located at the end of the nozzle arrangement (4.4) to seal the inlet port (4.5) to the nozzle house (4.3) cavity.

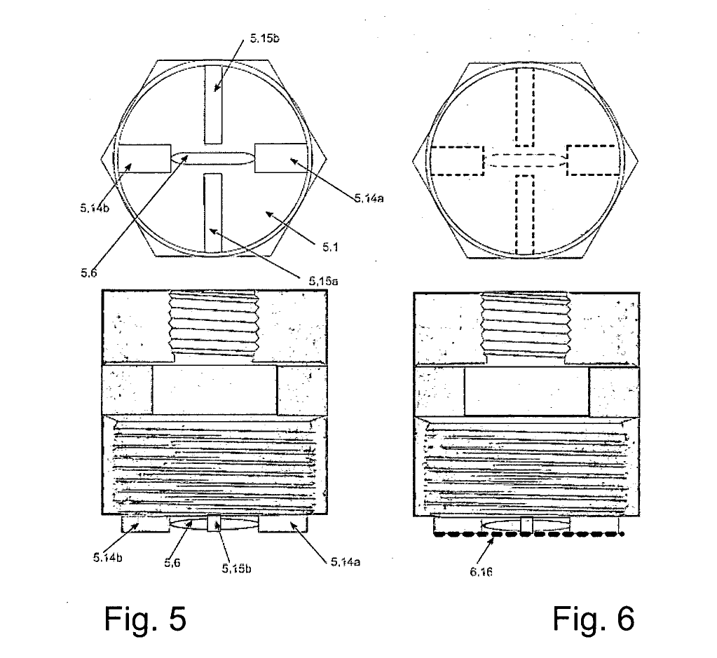

FIG. 5 shows an example on the invention where the surface (5.1) of the spherical plate body pointing away from the nozzle housing cavity have fines or obstruction materials (5.15a, 5.15b) or (5.14a, 5.14b) in extension or on an angle 10° to 90° to the thermal release element (5.6). The fines helps guiding hot air from fires to surround the thermal release element (5.6) to achieve fast thermal release of the thermal release element.

FIG. 6 shows an example on the invention as shown in FIG. 5. where the thermal release element is located between the spherical plate body located at the outlet of the nozzle cavity outlet and a extra plate body (6.16), located in parallel to the spherical plate at the cavity outlet. The extra plate body serves as a shield protecting the thermal release element against physical damages.

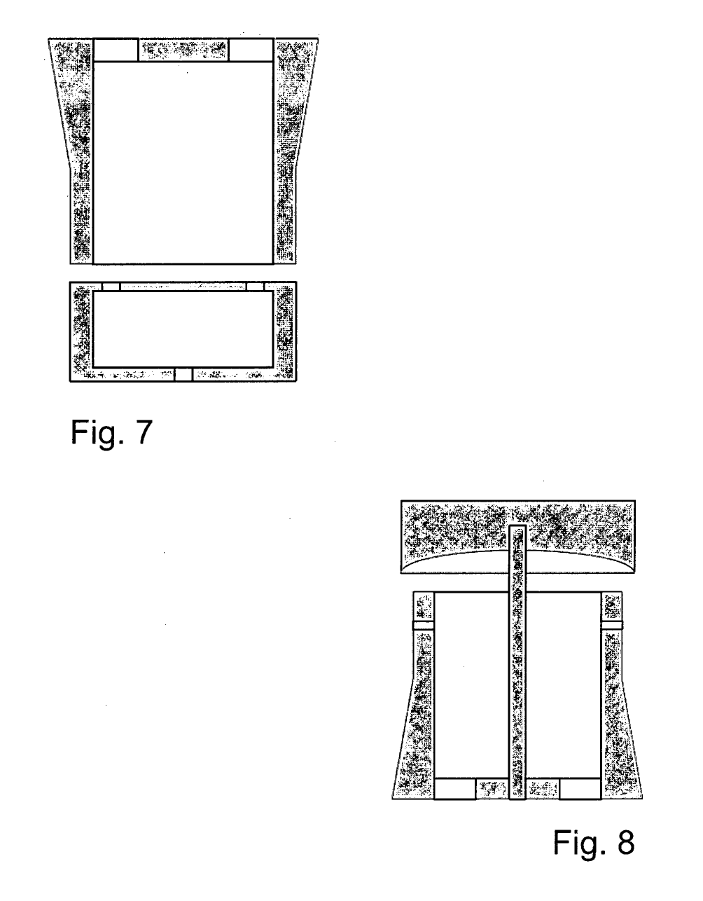

FIG. 7 shows an example on a nozzle body to be located in the nozzle housing cavity on a variant of the invention, where the nozzle body consists of two parts, where the nozzle body bottom part has the shape of a cup with openings in its bottom, and the nozzle body top part has one or more cavities each with one or more openings, with the opening bore in an angle <90° to the centreline of the cavity, and one opening centrally located to the cavity opposite the inlet openings. The variant of the invention functions with that the extinguishing agent flows through the openings in the cup of the bottom nozzle body. The extinguishing agent flows through the cup cavity to the slot between the bottom and top nozzle bodies, and extinguishing agent flows through the angled openings into nozzle top body cavity. The angled openings sets the extinguishing agent in rotations inside the nozzle top cavity, and the agent spins at high speeds breaking the extinguishing agent into small droplets when existing the centre opening to be delivered to the place on fire.

FIG. 8 shows an example on a nozzle body to be located in the nozzle housing cavity on a variant of the invention for installation in upright position, where the nozzle body consists of minimum two parts a bottom part and a top part, where the bottom part has the shape of a cup with openings in its body, and the nozzle body top part has a concave surface in a distance of 0.2 mm to 2 mm from the bottom part, and the bottom part has openings in the cylinder surface.

1. An automatic spray nozzle arrangement, which comprises a nozzle house with a cavity with an inlet port and an exit opening, where the cavity contains a nozzle body arrangement, which is characterized by that the cavity exit opening is closed with a spherical plate body which is fixed in its position with a locking arrangement with a thermal release element, which is positioned between two locking brackets.

2. An automatic spray nozzle arrangement of claim 1, which is characterized by that the end of the thermal release element rests on a spring.

3. An automatic spray nozzle arrangement of claim 1, which is characterized by that the one end of the thermal release element rests on a the end of a threaded rod.

4. An automatic spray nozzle arrangement of claim 1, which is characterized by that the spherical plate body forms a seal on the nozzle house cavity opening.

5. An automatic spray nozzle arrangement of claim 1, which is characterized by that the spherical plate body supply support to the nozzle body arrangement to fixate a seal on the nozzle house inlet port.

6. An automatic spray nozzle arrangement of claim 1, which is characterized by that the spherical plate body has flaps or fines or air guides on its surface where the thermal release element is located.

7. An automatic spray nozzle arrangement of claim 1, which is characterized by that the spherical plate body has one or more flaps or fins or air guides which is located in an angle which is less than 180° to the length axel of the heat sensitive element.

8. An automatic spray nozzle arrangement of claim 1, which is characterized by that the spherical plate body has a parallel plate body attached in a distance to the surface of the spherical plate body, which are larger that the diameter or thickness of the thermal release element, and where the thermal release element is located between the two parallel plate bodies.

9. An automatic spray nozzle arrangement of claim 1, which is characterized by that the nozzle arrangement body inside the nozzle house cavity consists of two assembled body parts, where the bottom nozzle part has the shape of a cup with openings in the cup bottom plate, and the top nozzle body part forms a nozzle with one or multiple nozzle openings.

10. An automatic spray nozzle arrangement of claim 1 for upright installation, which is characterized by that the nozzle body in the nozzle house cavity consists of a top nozzle body part having a concave surface facing the bottom nozzle body part and the cup cavity for a location of 0.2 mm to 2 mm from the cup cavity opening of the bottom nozzle body part.
